(19) United States
(12) Patent Application Publication
(10) Pub. No.: US 2011/0068909 A1
(43) Pub. Date: Mar. 24, 2011

(54) BATTERY-FREE REMOTE CONTROLLER

(76) Inventor: Jung Che Chang, Taichung City (TW)

(21) Appl. No.: 12/566,116

(22) Filed: Sep. 24, 2009

(51) Int. Cl. G08C 19/16; G08C 19/00; G05B 11/01

(52) U.S. Cl. 340/12.51

(57) ABSTRACT

A battery-free remote controller includes an antenna, a plurality of key switches, and at least one electronic tag. The antenna is electrically connected to the plurality of key switches, and each electronic tag is electrically connected to the antenna through at least one of the key switches. Each electronic tag is corresponding to a device classification code, and each key switch is corresponding to an operation code. When one of the key switches is turned on, the electronic tag connected to the key switch is electrically connected to the antenna. At this time, the electronic tag uses a radio frequency signal received by the antenna as a power supply to output a remote control code containing the device classification code corresponding to the electronic tag and the operation code corresponding to the key switch, and the antenna transmits the remote control code.

### BACKGROUND OF THE INVENTION

1. Field of Invention

The present invention relates to a remote control device, and more particularly to a battery-free remote controller that does not need an external power supply.

2. Related Art

Generally, household electronic devices, such as televisions, audio devices, and air conditioners, are all equipped with a matching remote controller. The remote controller facilitates the operation of the household electronic devices.

In a conventional remote controller, an external power supply such as a dry battery or a rechargeable battery is used to drive internal circuits of the remote controller. The battery provides a power supply to enable the remote controller to transmit a control signal to control a household electronic device.

The dry battery can only store limited electric power and is not reusable. Waste dry batteries may cause contamination and damage to the ecological environment. Also, the replacement of the dry battery increases the long-term operating cost of a user. Although the rechargeable battery can be recharged, the recharging process takes time and the price is higher.

Moreover, the size and weight of the battery also limit the design of the remote controller, causing ordinary remote controllers to have a large size and a heavy weight.

Furthermore, most conventional remote controllers use infrared signals. However, since the infrared signals are directional, in use, the remote controller cannot control the household electronic device to be operated unless the remote controller is pointed at the household electronic device, thereby causing operational inconvenience to the user.

In addition, different household electronic devices need to be equipped with different remote controllers for remote control. With the development of technologies, almost every household has many household electronic devices that can be remotely operated. Therefore, when the user wants to use a particular household electronic device, he/she often needs to find the corresponding remote controller from a number of remote controllers, which is rather inconvenient.

### SUMMARY OF THE INVENTION

In view of the above problems, the present invention is directed to a battery-free remote controller, so as to solve the problems that the remote controller in the prior art can only store limited electric power, is not environment friendly, requires a high operating cost, has limited design options, and is inconvenient to use.

A battery-free remote controller according to an embodiment of the present invention utilizes a radio frequency identification (RFID) technology to provide a desired power supply, such that it is unnecessary to additionally dispose an energy storage unit to provide the power supply required for operation.

A battery-free remote controller according to an embodiment of the present invention can transmit a non-directional carrier signal for remote control, so as to solve the problem that the remote controller cannot control a household electronic device to be operated unless the remote controller is pointed at the household electronic device.

A battery-free remote controller according to an embodiment of the present invention utilizes a multi-stage switch to remotely control a plurality of electronic devices, thereby achieving functions of a multi-purpose remote controller.

The present invention provides a battery-free remote controller, which comprises an antenna, a plurality of key switches, and at least one electronic tag. The antenna is electrically connected to the key switches, and the electronic tag is electrically connected to the antenna through the key switches. Each electronic tag is corresponding to a device classification code, and each key switch is corresponding to an operation code. When one of the key switches is turned on, the electronic tag connected to the key switch is electrically connected to the antenna. At this time, the electronic tag uses a radio frequency signal received by the antenna as a power supply to output a remote control code containing the device classification code corresponding to the electronic tag and the operation code corresponding to the key switch, and the antenna transmits the remote control code.

In an embodiment of the present invention, each electronic tag has a memory for storing the device classification code corresponding to the electronic tag and the operation codes corresponding to the key switches, in which each device classification code represents an electronic device.

In an embodiment of the present invention, the battery-free remote controller further comprises a multi-stage switch, and each stage of the multi-stage switch is electrically connected to a corresponding electronic tag.

In an embodiment of the present invention, the plurality of electronic tags is integrated into an integrated circuit chip. Alternatively, each electronic tag is an integrated circuit chip.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a battery-free remote controller according to a first embodiment of the present invention;

FIG. 2 is a schematic view of an internal structure of the battery-free remote controller with a single electronic tag according to the first embodiment of the present invention;

FIG. 3 is a schematic view of a battery-free remote controller according to a second embodiment of the present invention; and

FIG. 4 is a schematic view of an internal structure of the battery-free remote controller with a plurality of electronic tags according to the second embodiment of the present invention.

### DETAILED DESCRIPTION OF THE INVENTION

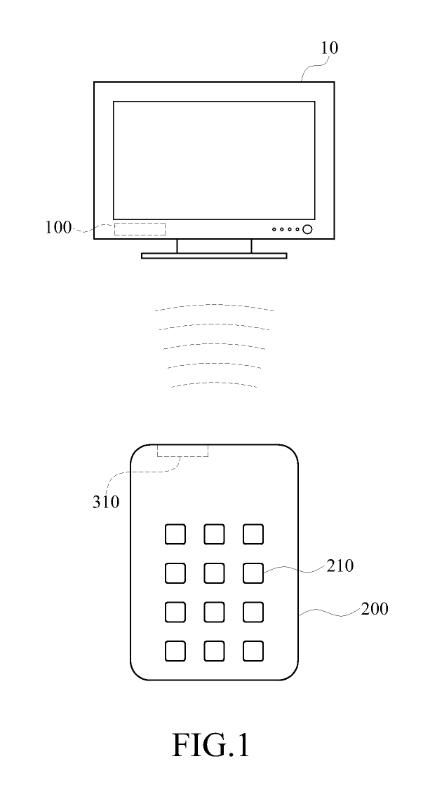

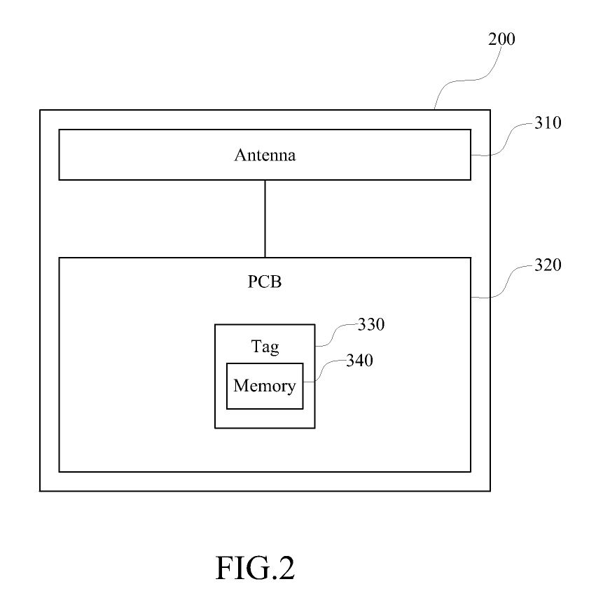

FIG. 1 is a schematic view of a battery-free remote controller 200 according to a first embodiment of the present invention. FIG. 2 is a schematic view of an internal structure of the battery-free remote controller 200 with a single electronic tag according to the first embodiment of the present invention. Referring to FIGS. 1 and 2, the battery-free remote controller 200 is used with an electronic device 10. In other words, the battery-free remote controller 200 is used for remotely controlling the electronic device 10. The electronic device 10 may be, but is not limited to, a television, an audio device, or an air conditioner.

Here, a corresponding reader 100 is disposed on the electronic device 10. Radio transmission of remote control signals is performed between the battery-free remote controller 200 and the reader 100 by using an RFID technology. In addition, the battery-free remote controller 200 utilizes the RFID technology to provide a desired power supply.

The battery-free remote controller 200 comprises an antenna 310, a printed circuit board (PCB) 320, an electronic tag 330, and a plurality of key switches 210. The electronic tag 330 has a memory 340 therein. In this embodiment, the memory 340 may be a non-volatile memory such as an electrically-erasable programmable read-only memory (EEPROM). The electronic tag 330 is a passive electronic tag. The memory 340 in the electronic tag 330 stores a device classification code and a plurality of operation codes. Different device classification codes are corresponding to different electronic devices 10. In addition, each key switch 210 is corresponding to an operation code, and each operation code represents a control operation, such as turn-on, turn-off, or volume adjustment.

Referring to FIGS. 1 and 2, in this embodiment, the antenna 310 and the plurality of key switches 210 are electrically connected to a circuit on the PCB 320. The electronic tag 330 is disposed on the PCB 320, and electrically connected to the circuit on the PCB. The electronic tag 330 is electrically connected to the antenna 310 through the circuit on the PCB 320. When one of the key switches 210 is triggered, the electronic tag 330 is electrically connected to the key switch 210 through the circuit on the PCB 320.

When one of the key switches 210 is triggered, the triggered key switch 210 enables the antenna 310 to be electrically connected to the electronic tag 330 through the circuit on the PCB 320. At this time, the electronic tag 330 receives a radio frequency signal transmitted by the reader 100 disposed on the electronic device 10 through the antenna 310. Meanwhile, an induced current is generated in the electronic tag 330 to drive the electronic tag 330, such that the battery-free remote controller 200 can operate without using an external power supply or battery.

After obtaining the power supply, the electronic tag 330 transmits a remote control code through the antenna 310. The remote control code is formed by the device classification code and an operation code stored in the memory 340. The operation code is corresponding to the triggered key switch. The reader 100 of the electronic device 10 receives the remote control code transmitted by the battery-free remote controller 200, demodulates and decodes the remote control code, and then transmits the remote control code to a control system (not shown) disposed in the electronic device 10. The control system firstly determines whether the device classification code is consistent with a device classification code of the electronic device 10. If the control system determines that the device classification code is the device classification code of the electronic device 10, the electronic device 10 operates according to the operation code corresponding to the key switch. If the control system determines that the device classification code is not the device classification code of the electronic device 10, the electronic device 10 does not operate.

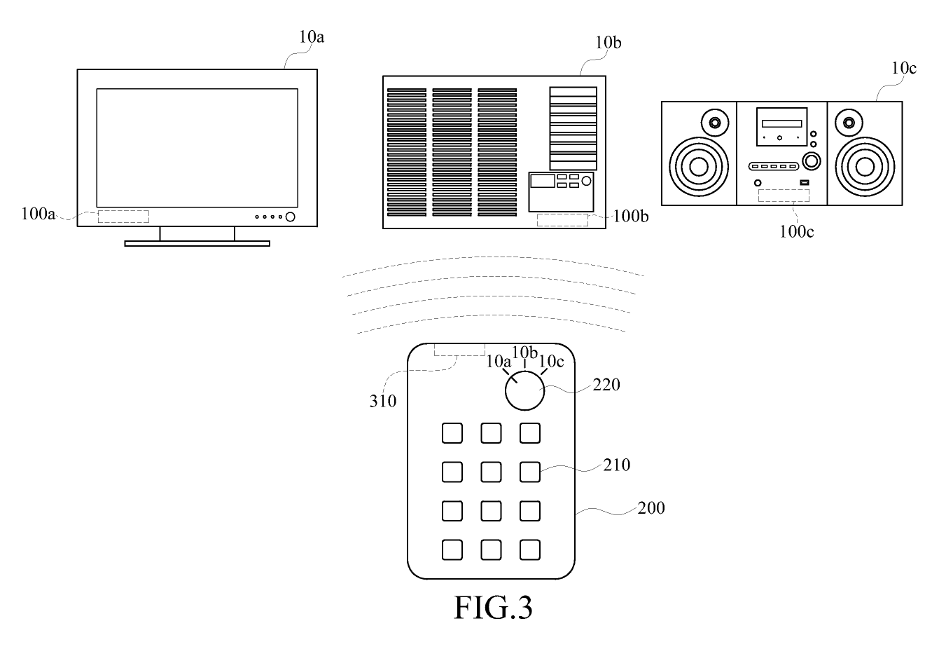

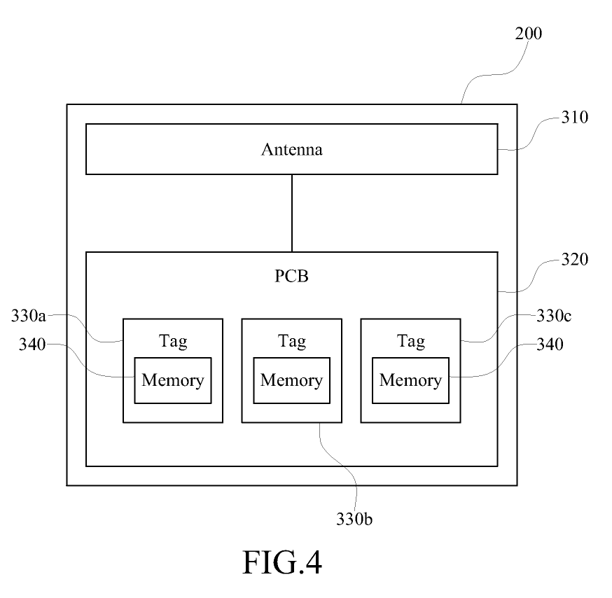

FIG. 3 is a schematic view of a battery-free remote controller 200 according to a second embodiment of the present invention. FIG. 4 is a schematic view of an internal structure of the battery-free remote controller 200 with a plurality of electronic tags according to the second embodiment of the present invention. Referring to FIGS. 3 and 4, the battery-free remote controller 200 is used with a plurality of electronic devices 10. Here, three electronic devices 10, namely, an electronic device 10a, an electronic device 10b, and an electronic device 10c, are taken as an example for the convenience of description. The battery-free remote controller 200 further comprises a multi-stage switch 220. The multi-stage switch 220 is electrically connected to a circuit on a PCB 320. In this embodiment, three electronic tags 330 are disposed on the PCB 320 of the battery-free remote controller 200, and each electronic tag 330 is electrically connected to the circuit on the PCB. However, persons skilled in the art may also dispose one or more electronic tags 330 on the PCB 320. Each electronic tag 330 controls an electronic device, and the number of the electronic tags 330 is determined by the number of electronic devices to be controlled. Therefore, the number of the electronic tags 330 is not limited to that disclosed in this embodiment.

Each electronic tag 330 has a memory 340 therein. Each memory 340 stores a device classification code and a plurality of operation codes. Different device classification codes are corresponding to different electronic devices. In this embodiment, three device classification codes of the three electronic tags 330 (which are respectively marked as 330a, 330b, and 330c below for the convenience of description) are corresponding to the electronic devices 10a, 10b, and 10c, respectively. In other words, the electronic device 10a is controlled by a remote control code generated by the electronic tag 330a by identifying the device classification code corresponding to the electronic tag 330a, the electronic device 10b is controlled by a remote control code generated by the electronic tag 330b by identifying the device classification code corresponding to the electronic tag 330b, and the electronic device 10c is controlled by a remote control code generated by the electronic tag 330c by identifying the device classification code corresponding to the electronic tag 330c. Each key switch 210 is corresponding to an operation code, and each operation code represents a control operation. Furthermore, each electronic device 10 has a reader 100. In this embodiment, the electronic device 10a has a reader 100a, the electronic device 10b has a reader 100b, and the electronic device 10c has a reader 100c.

The multi-stage switch 220 functions to switch an antenna 310 to be electrically connected to an electronic tag 330 through the circuit on the PCB 320. The antenna 310 and a plurality of key switches 210 are electrically connected to the circuit on the PCB 320. In addition, when a key switch 210 of the battery-free remote controller 200 is triggered, the electronic tag 330 is electrically connected to the triggered key switch 210 through the circuit on the PCB 330.

In the second embodiment, the multi-stage switch 220 is switched to the electronic device 10a. At this time, the electronic tag 330a corresponding to the electronic device 10a is electrically connected to the antenna 310 through the circuit on the PCB 320, such that the battery-free remote controller 200 controls the electronic device 10a.

Therefore, when a key switch 210 is triggered, the triggered key switch 210 enables the antenna 310 to be electrically connected to the electronic tag 330a connected to the multi-stage switch 220 through the circuit on the PCB 320. The electronic tag 330a receives a radio frequency signal transmitted by the reader 100a disposed on the electronic device 10a through the antenna 310. Meanwhile, an induced current is generated in the electronic tag 330a to drive the electronic tag 330a, such that the battery-free remote controller 200 can operate without using an external power supply or battery.

After obtaining the power supply, the electronic tag 330a transmits a remote control code through the antenna 310. The remote control code is formed by the device classification code and an operation code stored in the memory 340. The operation code is corresponding to the triggered key switch. The reader 100a of the electronic device 10a receives the remote control code transmitted by the battery-free remote controller 200, demodulates and decodes the remote control code, and then transmits the remote control code to a control system (not shown) disposed in the electronic device 10a. The control system firstly determines whether the device classification code is consistent with the device classification code of the electronic device 10a. If the control system determines that the device classification code is the device classification code of the electronic device 10a, the electronic device 10a operates according to the operation code corresponding to the key switch. If the control system determines that the device classification code is not the device classification code of the electronic device 10a, the electronic device 10a does not operate. Therefore, the multi-stage switch 220 can remotely control the electronic device 10a when switched to one electronic tag 330, can remotely control the electronic device 10b when switched to another electronic tag 330, and can remotely control the electronic device 10c when switched to the next electronic tag 330.

For example, the electronic device 10c is an audio device. When a key switch 210 of the battery-free remote controller 200 that is set to turn on a power supply is triggered, the triggered key switch 210 enables the antenna 310 to be electrically connected to the electronic tag 330c through the circuit on the PCB 320. At this time, the electronic tag 330c corresponding to the audio device receives a radio frequency signal transmitted by the reader 100c disposed on the audio device through the antenna 310. Meanwhile, an induced current is generated in the electronic tag 330c corresponding to the audio device to drive the electronic tag 330c, such that the battery-free remote controller 200 can operate without using an external power supply or battery. After obtaining the power supply, the electronic tag 330c transmits a remote control code through the antenna 310. The remote control code is formed by the device classification code and an operation code stored in the memory 340. In this embodiment, the operation code represents an operation of turning on the power supply, and the device classification code is a classification code representing the audio device. The reader 100c of the audio device receives the remote control code transmitted by the battery-free remote controller 200, demodulates and decodes the remote control code, and then transmits the remote control code to a control system (not shown) disposed in a television. The control system firstly determines whether the device classification code is consistent with a device classification code of the audio device, and turns on the power supply if the device classification code is consistent with the device classification code of the audio device.

The battery-free remote controller 200 uses frequencies above the ultrahigh frequency (UHF) band, such that the battery-free remote controller 200 can operate at a distance of more than 4 meters.

The three electronic tags 330 are integrated into an integrated circuit chip. Alternatively, each electronic tag may also be an integrated circuit chip respectively.

To sum up, as can be seen from the battery-free remote controller according to the above embodiments, in the battery-free remote controller, after an antenna is electrically connected to an electronic tag, the electronic tag receives a radio frequency signal transmitted by a reader disposed on a television device through the antenna. Meanwhile, an induced current is generated in the electronic tag to drive the electronic tag, such that the battery-free remote controller can normally operate without using an external power supply or battery. Thereby, the battery-free remote controller does not need the cost of batteries and avoids the environmental problem caused by waste batteries. In addition, the battery-free remote controller utilizes a multi-stage switch to remotely control a plurality of electronic devices, thereby achieving functions of a multi-purpose remote controller. Furthermore, the battery-free remote controller transmits a non-directional carrier signal, thereby eliminating the problem caused by directional signals.

What is claimed is:

1. A battery-free remote controller, comprising:
an antenna;
a plurality of key switches, electrically connected to the antenna, wherein each of the key switches is corresponding to an operation code;
at least one electronic tag, wherein each electronic tag is electrically connected to the antenna through at least one of the key switches, and each electronic tag is corresponding to a device classification code,
wherein when one of the key switches is turned on, the electronic tag connected to the key switch is electrically connected to the antenna, such that the electronic tag connected to the key switch uses a radio frequency signal received by the antenna as a power supply to output a remote control code containing the device classification code corresponding to the electronic tag and the operation code corresponding to the key switch, and the antenna transmits the output remote control code.

2. The battery-free remote controller according to claim 1, wherein each of the electronic tags has a memory for storing one of the device classification codes and the plurality of operation codes.

3. The battery-free remote controller according to claim 1, wherein the number of the at least one electronic tag is two or more, each of the electronic tags has a memory for storing one of the device classification codes and the plurality of operation codes, and each of the device classification codes represents a different device.

4. The battery-free remote controller according to claim 3, further comprising a multi-stage switch, wherein each stage of the multi-stage switch is electrically connected to the corresponding one of the electronic tags.

5. The battery-free remote controller according to claim 3, wherein the electronic tags are integrated into an integrated circuit chip.

6. The battery-free remote controller according to claim 1, wherein each of the electronic tags is an integrated circuit chip.
